(19) United States
(12) Patent Application Publication
(10) Pub. No.: US 2022/0317351 A1
(43) Pub. Date: Oct. 6, 2022

(54) ANGULAR FILTER

(71) Applicant: ISORG, Limoges CEDEX 3 (FR)

(72) Inventors: Tindara VERDUCI, GRENOBLE (FR); Benjamin BOUTHINON, GRENOBLE (FR); Emeline SARACCO, GRENOBLE (FR)

(21) Appl. No.: 17/642,176

(22) PCT Filed: Sep. 8, 2020
(86) PCT No.: PCT/EP2020/075049

§ 371 Date: Mar. 10, 2022

(30) Foreign Application Priority Data
Sep. 13, 2019 (FR) FR19/10119

(51) Int. Cl. G02B 5/20

(52) U.S. Cl. CPC G02B 5/208

(57) ABSTRACT

An angular filter for an image sensor includes opaque resin patterns at least partially covered with a first humidity-tight layer.

The present patent application claims the priority benefit of French patent application FR19/10119 which is herein incorporated by reference.

### FIELD

The present disclosure concerns an angular filter for an image sensor.

### BACKGROUND

An angular filter is a device enabling to filter an incident radiation according to the incidence of this radiation and thus blocks rays having an incidence greater than a desired angle, called maximum incidence.

### SUMMARY

There is a need to improve angular filters.

An embodiment provides an angular filter for an image sensor comprising opaque resin patterns at least partially covered with a first humidity-tight layer.

According to an embodiment, the patterns are totally encapsulated between said first layer and a second humidity-tight layer.

An embodiment provides an angular filter manufacturing method comprising the steps of:
forming opaque resin patterns; and
covering the patterns with a first humidity-tight layer.

According to an embodiment, the method further comprises the deposition of a second humidity-tight layer before the forming of the resin patterns.

According to an embodiment, the layer(s) are opaque to UV radiations.

According to an embodiment, the resin is black or colored.

According to an embodiment, the resin is positive.

According to an embodiment, the resin patterns have, in cross-section, rectangular or trapezoidal shapes.

According to an embodiment, the layer(s) have a thickness in the range from 1 to 200 nm, preferably in the range from 10 to 50 nm.

According to an embodiment, the first layer, one of the layers, or the layers are made of Al₂O₃.

According to an embodiment, the first layer, one of the layers, or the layers are made of SiN/SiO₂.

According to an embodiment, the space between the resin patterns is filled with gas, preferably with air.

According to an embodiment, the space between the resin patterns is filled with a material transparent to wavelengths in the range from 400 nm to 1 mm, preferably from 400 to 700 nm.

According to an embodiment, the material is selected from among silicone, polydimethylsiloxane, an acrylate resin, an epoxy resin, and an optically clear adhesive.

According to an embodiment, the first and/or the second layer are deposited by an atomic layer deposition method, a plasma-enhanced chemical vapor deposition method, or a physical vapor deposition method.

According to an embodiment, the resin and the material are deposited by liquid deposition, by centrifugation, or by coating.

### BRIEF DESCRIPTION OF THE DRAWINGS

The foregoing and other features and advantages of the present invention will be discussed in detail in the following non-limiting description of specific implementation modes in connection with the accompanying drawing, in which:

FIG. 1 is a partial simplified cross-section view of an implementation mode of an image acquisition system;

FIG. 2 is a partial simplified cross-section view of an example of an angular filter;

FIG. 3 partially and schematically shows, in cross-section views (A), (B), and (C), steps of an angular filter manufacturing mode;

FIG. 4 partially and schematically shows, in cross-section views (A), (B), (C), and (D), steps of another angular filter manufacturing mode;

FIG. 5 is a partial simplified cross-section view of an alternative implementation of an angular filter; and

FIG. 6 is a partial simplified cross-section view of another alternative implementation of an angular filter.

### DESCRIPTION OF THE EMBODIMENTS

Like features have been designated by like references in the various figures. In particular, the structural and/or functional elements common to the different implementation modes and embodiments may be designated with the same reference numerals and may have identical structural, dimensional, and material properties.

For clarity, only those steps and elements which are useful to the understanding of the described implementation modes have been shown and are detailed. In particular, the forming of the image sensor and of the elements other than the angular filter have not been detailed, the described embodiments and implementation modes being compatible with usual embodiments of the sensor and of these other elements.

Unless specified otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless otherwise specified, when reference is made to absolute positional qualifiers, such as the terms “front”, “back”, “top”, “bottom”, “left”, “right”, etc., or to relative positional qualifiers, such as the terms “above”, “below”, “upper”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

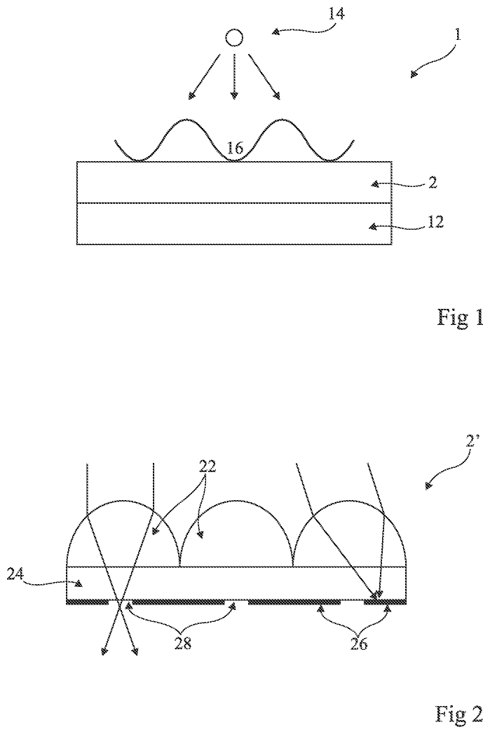

FIG. 1 is a partial simplified cross-section view of an embodiment of an image acquisition system 1.

This drawing illustrates the presence of an object 16, partially shown, having its image response captured by image acquisition system 1. Image acquisition system 1 comprises, from bottom to top in the orientation of the drawing:
an image sensor 12, for example, a CMOS sensor or a sensor based on thin film transistors (TFT), which may be coupled to inorganic (crystal silicon for a CMOS sensor or amorphous silicon for a TFT sensor) or organic photodiodes;
an angular filter 2; and
a light source 14.

Light source 14 is illustrated above object 16. It may however, as a variant, be located between object 16 and angular filter 2.

The radiation emitted by light source 14 may be a visible radiation, from 400 to 700 nm, and/or an infrared radiation from 700 nm to 1 mm. In the case of an application to the determination of fingerprints, object 16 corresponds to a user's finger.

FIG. 2 is a partial simplified cross-section view of an example of a usual angular filter 2′.

Angular filter 2′ is formed, from top to bottom in the orientation of the drawing:
of microlenses 22;
of a substrate or support 24; and
of walls or patterns 26 resting on substrate 24 and delimiting holes 28.

In the sense of the present disclosure, “transparent” designates a material giving way to more than 1% of the radiation in the concerned wavelengths and “opaque” designates a material giving way to less than 1% of the radiation in the concerned wavelengths.

The walls correspond to resin patterns 26. This resin is made of a material absorbing at least at the wavelengths to be filtered. The resin may be a black resin absorbing in the visible and infrared range or a colored resin absorbing visible light of a given color. Resin patterns 26 may, in cross-section, have rectangular or trapezoidal shapes. The space between two patterns 26 is defined as a hole 28.

Substrate 24 may be made of a clear polymer which does not absorb at least the considered wavelengths, here in the visible and infrared range. The polymer may in particular be made of polyethylene terephthalate PET, poly(methyl methacrylate) PMMA, cyclic olefin polymer (COP), polyimide (PI), polycarbonate (PC). The thickness of substrate 24 may for example vary from 1 to 100 μm, preferably from 20 to 100 μm. Substrate 24 may correspond to a colored filter, to a polarizer, to a half-wave plate or to a quarter-wave plate.

In front of each hole 28 is located a microlens 22. Each hole 28 is substantially centered on the focus of the associated microlens 22. Microlenses 22 may be made of silica, of PMMA, of epoxy resin or of acrylate resin.

Thus, the rays emitted by light source 14 are focused by microlenses 22 at their contacts. The rays focused into the holes 28 of angular filter 2′ are captured by photodetectors present at the outlet of the filter, in image sensor 12. The rays focused onto resin patterns 26 are absorbed by the latter.

The inventors have observed that out of normal conditions of use corresponding to an ambient temperature from 0 to 40° C., to an atmospheric pressure of approximately 1,013 hPa, and to a relative humidity in the range from 20 to 50%, typically at an ambient temperature of approximately 80° C. with a relative humidity of approximately 80%, angular filter 2′ undergoes an accelerated aging. Resin 26 becomes unstable and holes 28 close, which alters the properties of filter 2′. The exposure to a UV radiation, which is an electromagnetic radiation having a wavelength in the range from 10 to 400 nm, may further accelerate this phenomenon.

The described implementation modes and embodiments provide partially or totally encapsulating the resin patterns 26 of filter 2′, to protect them at least from humidity and, preferably from UV radiations. The material encapsulating the patterns may also, according to its nature, be air-tight.

In the sense of the present disclosure, called “tight” a material having a water vapor transmission rate (WVTR) smaller than 10 g/day/m².

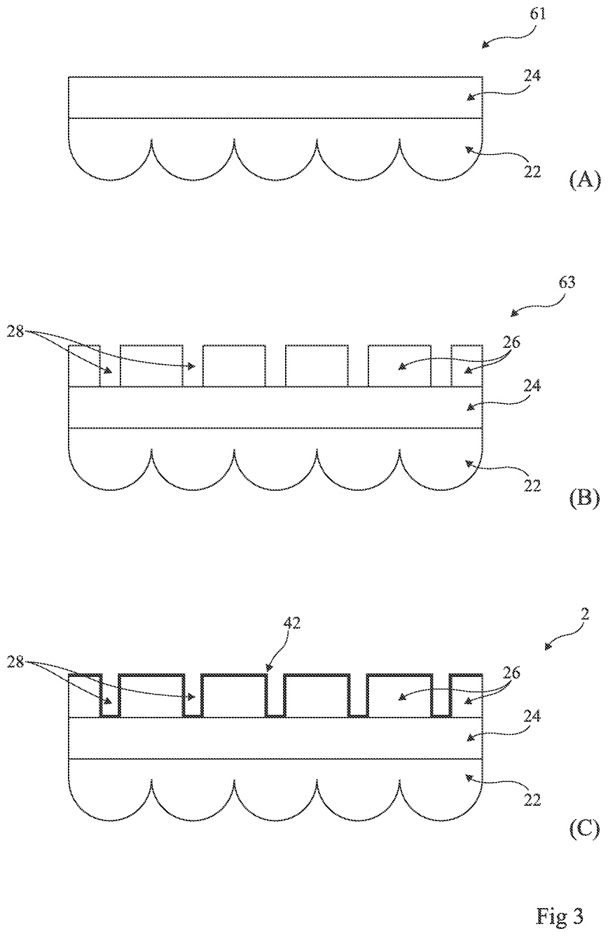

FIG. 3 partially and schematically shows, in views (A), (B), and (C), steps of a method of manufacturing an angular filter 2.

View (A) partially and schematically shows a stack 61 of microlenses 22 and of a substrate 24.

View (B) partially and schematically shows a stack 63 of substrate 24 and of microlenses 22, and of resin patterns 26.

This stack 63 may correspond to a usual angular filter such as the filter 2′ of FIG. 2.

An implementation mode of a method of manufacturing the stack 63 shown in view (B) of FIG. 3 comprises the steps of:
deposition of an opaque positive resin (colored or black) on substrate 24, by centrifugation or coating;
photolithography of patterns to be etched in the resin; and
development of the resin (photolithographic etching) to only keep patterns 26.

Another implementation mode of a method of manufacturing the stack 63 shown in view (B) of FIG. 3 comprises the steps of:
forming on substrate 24 and by photolithographic etching steps a transparent resin mold, having a shape complementary to the desired shape of patterns 26;
filling the mold with the resin (colored or black) forming patterns 26; and
removing the mold, for example, by a “lift-off” method.

Another implementation mode of a method of manufacturing the stack 63 shown in view (B) of FIG. 3 comprises the steps of:
depositing a resin film (colored or black) on substrate 24, by coating or centrifugation; and
perforating the resin film.

The perforation may be performed by using a micro-perforation tool for example comprising micro-needles to obtain the desired dimensions of holes 28 and pitch of holes 28, corresponding to patterns 26.

As a variant, the perforation of the film may be performed by laser ablation.

View (C) of FIG. 3 partially and schematically shows an angular filter 2.

According to this embodiment, the resin patterns 26 of the stack 63 of view (B) of FIG. 3 are covered with a first layer 42 tight at least to humidity and, preferably, opaque to UV radiations.

An implementation mode of a method of manufacturing the angular filter 2 shown in view (C) of FIG. 3 comprises the conformal deposition of an Al₂O₃ layer 42 by an atomic layer deposition (ALD) method. Layer 42 then has, for example, a thickness in the range from approximately 1 to 50 nm, preferably from 10 to 50 nm.

Another implementation mode of a method of manufacturing the angular filter 2 shown in view (C) of FIG. 3 comprises the conformal deposition of a SiN/SiO₂ layer 42 by a plasma enhanced chemical vapor deposition (PECVD) method. Layer 42 then has, for example, a thickness in the range from approximately 10 to 200 nm, preferably from 10 to 50 nm.

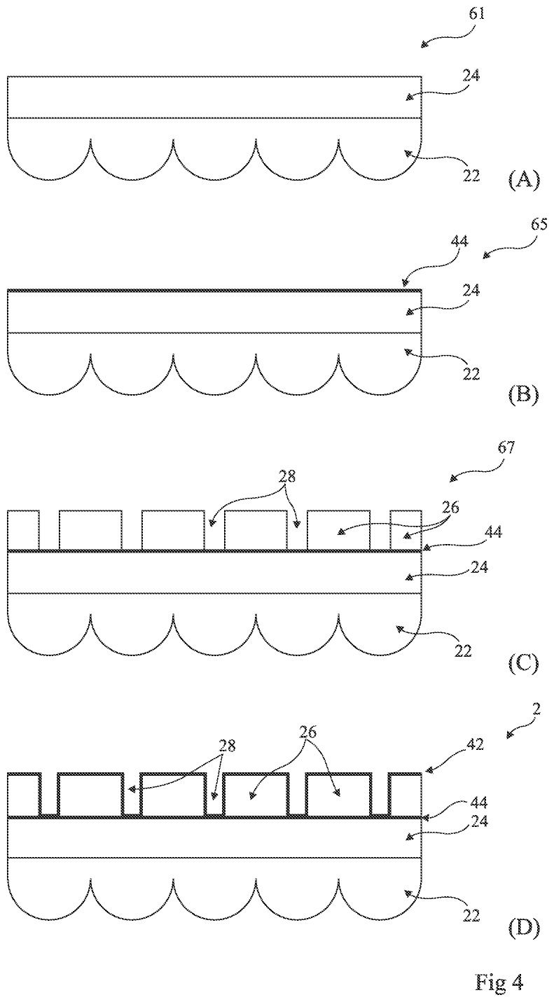

FIG. 4 partially and schematically shows, in cross-section views (A), (B), (C), and (D), steps of another manufacturing mode of an angular filter 2.

View (A) partially and schematically shows stack 61 of microlenses 22 and of substrate 24.

View (B) partially and schematically shows a stack 65 of substrate 24 and of microlenses 22, and of a second layer 44 tight at least to humidity and, preferably, opaque to UV radiations.

An implementation mode of a method of manufacturing the stack 65 shown in view (B) of FIG. 4 comprises the full plate deposition, on substrate 24, of an Al₂O₃ layer 44 by an atomic layer deposition (ALD) method. Layer 44 then has, for example, a thickness in the range from approximately 1 to 50 nm, preferably from 10 to 50 nm.

Another implementation mode of a method of manufacturing the stack 65 shown in view (B) of FIG. 4 comprises the full plate deposition, on substrate 24, of a SiN/SiO₂ layer 44 by a plasma-enhanced chemical vapor deposition (PECVD) method. Layer 44 then has, for example, a thickness in the range from approximately 10 to 200 nm, preferably from 10 to 50 nm.

View (C) of FIG. 4 partially and schematically shows a stack 67 of layer 44, of substrate 24, and of microlenses 22, and of resin patterns 26.

An implementation mode of a method of manufacturing the stack 67 shown in view (C) of FIG. 4 comprises, in the same way as for step (B) of FIG. 3, the steps of:
deposition of an opaque positive resin (colored or black) on tight layer 44, by coating or centrifugation;
photolithography of patterns to be etched in the colored or black resin; and
development of the resin (photolithographic etching) to only keep patterns 26.

Another implementation mode of a method of manufacturing the stack 67 shown in view (C) of FIG. 4 comprises, in the same way as for step (B) of FIG. 3, the steps of:
forming a transparent resin mold, on tight layer 44, by photolithographic etching steps, having a shape complementary to the desired shape of patterns 26;
filling the mold with the resin (black or colored) forming patterns 26; and
removing the mold, for example, by a “lift-off” method.

Another implementation mode of a method of manufacturing the stack 67 shown in view (C) of FIG. 4 comprises, as for step (B) of FIG. 3, the steps of:
depositing a resin film (colored or black) on tight layer 44, by coating or centrifugation; and
perforating the resin film.

The perforation may be performed by using a micro-perforation tool for example comprising micro-needles to obtain the desired dimensions of holes 28 and pitch of holes 28, corresponding to patterns 26.

As a variant, the perforation of the film may be performed by laser ablation.

View (D) of FIG. 4 partially and schematically shows an angular filter 2.

According to this embodiment, the resin patterns 26 of the stack 67 of view (C) of FIG. 4 are covered with a layer 42 tight at least to humidity and, preferably, opaque to UV radiations.

Thus, as compared with the embodiment of FIG. 3, the embodiment of FIG. 4 provides a full encapsulation of resin patterns 26.

An implementation mode of a method of manufacturing the angular filter 2 shown in view (D) of FIG. 4 comprises the conformal deposition of an Al₂O₃ layer by an atomic layer deposition (ALD) method. Layer 42 then has, for example, a thickness in the range from approximately 1 to 50 nm, preferably from 10 to 50 nm.

Another implementation mode of a method of manufacturing the angular filter 2 shown in view (D) of FIG. 4 comprises the conformal deposition of a SiN/SiO₂ layer by a plasma-enhanced chemical vapor deposition (PECVD) method. Layer 42 then has, for example, a thickness in the range from approximately 10 to 200 nm, preferably from 10 to 50 nm.

In the embodiments of FIGS. 3 and 4, holes 28 are left empty or filled with air or gas, sensor 12 (FIG. 1) resting on patterns 26.

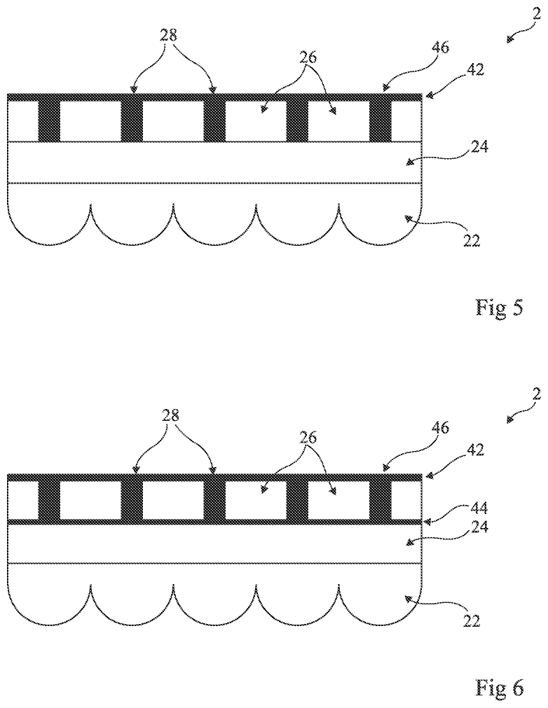

FIG. 5 is a partial simplified cross-section view of an alternative implementation of an angular filter 2.

According to this variant, after the steps detailed in FIG. 3, a deposition by spreading, by centrifugation, or by coating, of a humidity-tight filling material 46 is performed. Material 46 is totally transparent in the visible and infrared range. The thickness of material 46 is for example in the range from 1 nm to 50 μm, preferably from 1 nm to 25 μm. Material 46 may be silicone, polydimethylsiloxane PDMS, an epoxy resin, an acrylate resin, or an optically clear adhesive (OCA).

An advantage induced by the filling of holes 28 is that this enables to perform, at step (C) of FIG. 3, a non-conformal deposition at the level of the covering of resin patterns 26.

Thus, this step (C) may be a (non-conformal) deposition of SiN/SiO₂ by physical vapor deposition (PVD).

FIG. 6 is a partial simplified cross-section view of another alternative implementation of an angular filter 2.

According to this variant, after the steps detailed in FIG. 4, a deposition by spreading, by centrifugation, or by coating, of a humidity-tight filling material 46 is performed. Material 46 is totally transparent in the wavelengths of interest for the image sensor, preferably transparent in the visible range. The thickness of material is for example in the range from 1 nm to 25 μm, preferably from 10 nm to 3 μm. Material 46 may be silicone, polydimethylsiloxane PDMS, an epoxy resin, an acrylate resin, or an optically clear adhesive (OCA—Optical Clear Adhesive).

As for the variant of FIG. 5, such a filling of holes 28 enables to perform at step (D) of FIG. 4 a non-conformal deposition at the level of the covering of resin patterns 26.

Thus, this step (D) may be a (non-conformal) deposition of SiN/SiO₂ by physical vapor deposition (PVD).

In the embodiments of FIGS. 5 and 6, sensor 12 rests at the surface of material 46.

An advantage of the described embodiments and implementation modes is to improve the stability of the form factor of the holes 28 of the angular filter. Angular filters 2 undergo no accelerated aging and their lifetimes are thus lengthened.

Another advantage of the described embodiments and implementation modes is that they are compatible with usual deposition and etching techniques.

Various implementation modes and variants have been described. Those skilled in the art will understand that certain features of these various implementation modes and variants may be combined, and other variants will occur to those skilled in the art. In particular, the choice between the different modes of deposition of the encapsulation layers depends on the application and, for example, on the available technologies. Further, the opacity and transparency level depends on the materials used.

Finally, the practical implementation of the described implementation modes and variants is within the abilities of those skilled in the art based on the functional indications given hereabove.

1. An angular filter for an image sensor comprising: opaque resin patterns at least partially covered with a first humidity-tight layer.

2. The filter according to claim 1, wherein the patterns are totally encapsulated between said first layer and a second humidity-tight layer.

3. The filter according to claim 1, wherein the layer are opaque to UV radiations.

4. The filter according to claim 1, wherein the resin is black or colored.

5. The filter according to claim 1, wherein the resin is positive.

6. The filter according to claim 1, wherein the resin patterns have, in cross-section, rectangular or trapezoidal shapes.

7. The filter according to claim 1, wherein the layer has a thickness in the range from 1 to 200 nm or in the range from 10 to 50 nm.

8. The filter according to claim 1, wherein the first layer, one of the first layer and a second humidity-tight layer, or the first and second layers are made of Al₂O₃.

9. The filter according to claim 1, wherein the first layer, one of the first layer and a second humidity-tight layer, or the first and second layers are made of SiN/SiO₂.

10. The filter according to claim 1, wherein a space between the resin patterns is filled with a gas or with air.

11. The filter according to claim 1, wherein a space between the resin patterns is filled with a material transparent to wavelengths in the range from 400 nm to 1 mm or from 400 to 700 nm.

12. The filter according to claim 11, wherein the material is selected from silicone, polydimethylsiloxane, an acrylate resin, an epoxy resin, and an optically clear adhesive.

13. The filter according to claim 11, wherein the resin and the material are deposited by liquid deposition, by centrifugation, or by coating.

14. The filter according to claim 1, wherein the first and/or a second layer are deposited by an atomic layer deposition method, a plasma-enhanced chemical vapor deposition method, or a physical vapor deposition method.

15. A method of manufacturing an angular filter, according to claim 1, comprising the steps of:
forming opaque resin patterns; and
covering the patterns with a first humidity-tight layer.

16. The method according to claim 15, further comprising the step of: depositing a second humidity-tight layer before the forming of the resin patterns.
